(19) United States
(12) Patent Application Publication
(10) Pub. No.: US 2025/0128505 A1
(43) Pub. Date: Apr. 24, 2025

(54) PAPER WEB AND METHOD FOR FORMING A PAPER WEB

(71) Applicant: Mondi AG, Vienna (AT)

(72) Inventors: Lars Göran BERGLUND, Sundsvall (SE); Dawid FIFIELSKI, Sulnowo (PL); Gajos MARCIN, Sulnowo (PL); Paulus GOESS, Klagenfurt (AT); Elisabeth SCHWAIGER, St Stefan (AT)

(73) Assignee: Mondi AG, Vienna (AT)

(21) Appl. No.: 18/720,643

(22) PCT Filed: Nov. 30, 2022
(86) PCT No.: PCT/AT2022/060419

§ 371 Date: Jun. 16, 2024

(30) Foreign Application Priority Data
Dec. 23, 2021 (AT) A 51043/2021

(51) Int. Cl. B32B 29/00; B32B 37/20; B32B 38/08; D21H 17/20; D21H 21/22; D21H 27/30

(52) U.S. Cl. CPC B32B 29/005; B32B 37/20; B32B 38/08; D21H 17/20; D21H 21/22; D21H 27/30; B32B 2260/028; B32B 2260/046; B32B 2305/07; B32B 2307/54; B32B 2307/718; B32B 2307/72; B32B 2307/724; B32B 2307/726; B32B 2317/125

(57) ABSTRACT

The invention relates to a method for producing a paper web which is suitable for and/or designed to form a layer, in particular the core layer of a laminated board, by impregnating the paper web with a resin and subsequently curing the resin, comprising:—a first paper layer (1) made of a first material (3), and—a second paper layer (2) which is connected to the first paper layer (1) over the surface thereof and which is made of a second material (4), wherein—the first material (3) of the first paper layer (1) has a higher degree of absorbency for the resin than the second material (4) of the second paper layer (2). The invention is characterized in that—the second paper layer (2) is provided with an agent (5) for increasing the absorbency for the resin.

The invention relates to a paper web which is suitable for and/or configured to form the core layer of a laminated board, by impregnating the paper web with a resin and subsequent curing of the resin. The invention further relates to a method for producing this kind of paper web.

In principle, it is known to form the core layer of a laminated board using a layered structure made of paper. For this purpose, a paper web with a relatively high grammage and high absorbency is impregnated with a resin, stacked in several layers and then cured. Such core layers are used to form the core of furniture boards, laminate flooring, facade boards or other objects or laminated boards.

The paper webs used for this purpose must have certain properties in order to be usable in an industrial manufacturing process:

The paper web requires sufficient wet tensile strength to be able to be impregnated with a resin without damage. This is usually achieved by continuously drawing the paper web through a resin bath. If the wet tensile strength of the paper web in the machine direction is too low, there is a risk that the paper web will tear or at least partially tear.

Furthermore, the paper web should have a sufficient grammage or thickness so that the number of layers required to form the core can be kept low.

For efficiency reasons, the base material for the paper web should be selected as cost-effectively as possible, but also as environmentally friendly as possible. Recovered paper, i.e. recycled paper, would both reduce costs and cover the environmental aspect, although the environmental aspect can also be covered by fresh fibre material. However, recovered paper generally does not have sufficient wet tensile strength for the present application. A continuous layer with a high fresh fibre content would increase the wet tensile strength, but also increases the cost of the base material.

The wet tensile strength can be specifically controlled through the targeted use of fresh fibres mixed with recovered paper. This also allows for optionally avoiding permanent wet strength agents and achieving the product properties using temporary wet strength agents. Overall, this creates more flexibility in the choice of process chemistry.

Furthermore, the specific use of fresh fibres in mixed with recovered paper opens up opportunities to reduce the grammage of the paper web, as the strength, especially the wet tensile strength, can be adjusted by the pulp composition.

Now, the object of the invention is to overcome the disadvantages of the prior art and, in particular, to create a paper web which enables an efficient and environmentally friendly industrial production of layers or core layers of laminated boards.

According to the invention, the paper web is provided with a first paper layer made of a first material, which is planarly bonded to a second paper layer made of a second material. The first material of the first paper layer preferably has a high fresh fibre content and is in particular fresh paper. The second paper layer preferably has a higher recovered paper content than the first paper layer or is made of recovered paper. This allows a paper web with a high grammage to be produced at relatively low cost.

In practice, however, the problem arises that due to the different materials of the two paper layers, the two paper layers have different absorbencies.

According to the invention, it can therefore be provided that the second paper layer is provided with an agent for increasing the resin absorbency. The absorbency of the second paper layer is preferably increased in all embodiments by the agent reducing the surface tension of the resin that penetrates or comes into contact with the second paper layer or by improving capillarity.

The invention relates in particular to a paper web which is suitable for and/or configured to form the core layer of a laminated board, by impregnating the paper web with a resin and subsequent curing of the resin, comprising:
a first paper layer made of a first material
a second paper layer which is planarly bonded to the first paper layer and is made of a second material,
wherein the first material of the first paper layer has a higher degree of resin absorbency than the second material of the second paper layer.

The two paper layers are preferably inseparable or firmly bonded together. In particular, the two paper layers are joined together to form a joint paper web. In particular, the materials of the two paper layers can be mixed together in their contact area.

Preferably, it is provided that the second paper layer is provided with an agent for increasing the resin absorbency.

The agent for increasing the absorbency may be or may contain an agent for improving the capillarity of the second paper layer and/or may be or may contain an agent for improving the penetration of the resin at the paper-resin contact interface and/or may be or may contain an agent for reducing the surface tension of the resin and/or may be or may contain surfactants.

In particular, the agent may include non-ionic, cationic, anionic, but preferably always generally non-foaming surfactants. For example, the agent may comprise ethoxylated alcohols based on C12-C14.

In particular, the agent may be a non-ionic, cationic, anionic, but preferably always generally a non-foaming surfactant. For example, the agent may be ethoxylated alcohol based on C12-C14.

The agent can be a surfactant, in particular also a mixture of different surfactants such as a mixture of a non-ionic and/or cationic and/or anionic surfactant. The agent can also be a mixture of different ethoxylated alcohols based on C12-C14.

Optionally, it is provided that the agent is provided substantially dry in or on the second paper layer of the finished paper web and, on contact with the liquid resin, reduces the surface tension thereof and thereby increases the absorbency of the second paper layer.

Optionally, it is provided that the second paper layer in the dry state contains between 20 g/t and 40 g/t, preferably about 30 g/t to 35 g/t, of the agent.

Optionally, it is provided that the second material of the second paper layer without the agent for increasing the absorbency has a 20% to 90% lower resin absorbency than the first material of the first paper layer, the absorbency being the capillary rise after 10 min in machine direction determined according to the international standard ISO 8787:1986.

Optionally, it is provided that the first paper layer has an absorbency according to ISO 8787:1986 after 10 minutes of 25 to 90 mm in the paper machine direction.

Optionally, it is provided that the second paper layer provided with the agent for increasing the absorbency has an absorbency according to ISO 8787:1986 of 19 to 85 mm in the paper machine direction after 10 minutes.

Optionally, it is provided that the first paper layer has a greater absorbency than the second paper layer by a maximum of 30%.

Optionally, it is provided that the first material of the first paper layer has a higher fresh fibre content than the second material of the second paper layer.

Optionally, it is provided that the second material of the second paper layer has a higher recovered paper content than the first material of the first paper layer.

Optionally, it is provided that the first material of the first paper layer contains up to 100% fresh fibre and/or up to max. 30% recovered paper.

Optionally, it is provided that the second material of the second paper layer contains up to 100% recovered paper.

Optionally, it is provided that the total ash content in the paper web is 2-12% according to ISO 2144:2019.

Optionally, it is provided that the paper web has a grammage of 140 to 250 g/m² according to the ISO 536:2019 standard.

Optionally, it is provided that the paper web has a density of 450 to 580 kg/m³ according to the ISO 534:2011 standard.

Optionally, it is provided that the paper web has an air permeability according to Gurley of 6 to 20 s according to the ISO 5636-5:2013 standard.

Optionally, it is provided that the paper web has a wet tensile strength in the machine direction of 0.9 to 1.6 kN/m according to the ISO 3781:2011 standard.

Optionally, it is provided that the paper web has a pH value in the cold water extract of 6.6 to 8.5 according to the ISO 6588-1:2020 standard.

Optionally, it is provided that the paper web has an average length-weighted fibre length of 1.6 to 2.2 mm according to the ISO 16065-2:2014 standard.

Optionally, it is provided that the paper web is designed as a double layer impregnable kraft paper, i.e. in particular as a so-called double layer saturating kraft paper.

In particular, the invention relates to a method for producing a paper web which is suitable for and/or configured to form the core layer of a laminated board, by impregnating the paper web with a resin and subsequent curing of the resin. The paper web is preferably configured according to the invention.

The method preferably comprises the following steps: forming a paper web, having a first paper layer made of a first material and a second paper layer which is planarly bonded to the first paper layer and is made of a second material.

Preferably, it is provided that the first material of the first paper layer has a higher degree of resin absorbency than the second material of the second paper layer. In particular, this applies to a finished, i.e. substantially dry, paper web. A substantially dry paper web is a paper web that can have a commercially typical residual moisture content.

Preferably, it is provided that the second material of the second paper layer is provided with an agent for increasing the resin absorbency.

Optionally, it is provided that the agent for increasing the absorbency is an agent for reducing the surface tension of the resin and in particular contains surfactants.

Optionally, it is provided that the agent contains non-ionic, cationic, anionic, but preferably always non-foaming surfactants or is such a surfactant or a mixture of such surfactants.

Optionally, it is provided that a first pulp suspension for forming the first paper layer from the first material is applied to a first wire section to form a first fibre web.

Optionally, it is provided that a second pulp suspension for forming the second paper layer from the second material is applied to a second wire section to form a second fibre web.

Optionally, it is provided that subsequently in particular in a press section the first fibre web and the second fibre web are planarly bonded together and dried in a dryer section to form the paper web. Optionally, this can also be done in the wire section.

Optionally, it is provided that the second fibre web or the second paper layer is provided with the agent for increasing absorbency after the wire section and/or in the dryer section.

Optionally, it is provided that the agent for increasing the absorbency is applied in liquid form, in particular in an aqueous solution, to the second fibre web or to the second paper layer or is introduced into the second paper layer. In particular, this is done evenly and over the entire surface.

Optionally, it is provided that the agent is dried together with the two materials of the paper layers in the dryer section.

Optionally, it is provided that the agent is provided substantially dry in or on the second paper layer of the finished paper web and, on contact with the liquid resin, reduces the surface tension thereof and thereby increases the absorbency of the second paper layer.

Preferably in all embodiments, it is provided that the second paper layer is provided with an agent for increasing the resin absorbency. The first paper layer preferably does not comprise such an agent.

The paper web is preferably used to form the core layer of a laminated board. Laminated boards are, for example, furniture boards, laminate flooring, facade boards or similar objects.

The core is usually arranged in the centre and covered or strapped on both sides with one or more layers.

In the case of laminate flooring, for example, the core has a decorative layer on its upper side, which is usually covered from above by an abrasion-resistant, transparent wear layer. A layer is usually applied to the back of the core, which acts as opposing tension and/or absorbs excess resin from the core during production.

Optionally, the laminated board is a furniture board that has a centrally arranged core, which is provided on both sides with a decorative layer and a sealing layer covering the decorative layer.

The core is preferably formed by placing several layers of the already resin-impregnated and dried paper web on top of each other, cutting it to size beforehand or afterwards and then curing it. Curing can take place, for example, under pressure and/or increased temperature.

The core formed by the paper web is usually dimensionally stable, substantially dry and sufficiently strong in order to be used as the core of a laminated board.

To impregnate the paper web with resin, it is preferably drawn through a resin bath, sprayed, coated and/or impregnated with resin on both sides. The agent to increase the absorbency provided on or in the second paper layer comes into contact with the resin and has the effect that the resin can impregnate the second paper layer more quickly and/or that the resin can penetrate more quickly.

In particular, the agent is configured as an agent for improving capillarity or for reducing the surface tension at the paper/resin interface. Preferably, the agent includes surfactants or is a surfactant. If the resin comes into contact with the agent, the surface tension of the resin is optionally reduced and the resin can impregnate the second paper layer more quickly and/or penetrate the second paper layer more quickly.

Preferably in all embodiments, it is provided that the agent increases the resin absorbency in the second paper layer, this increase being relative to the absorbency of the first paper layer.

Preferably in all embodiments, it is provided that only the second paper layer is provided with the agent for increasing the resin absorbency. This means that the agent only increases the absorbency of the second paper layer.

The first paper layer preferably does not comprise any agent and is therefore substantially free of the agent. As a result, the absorbency of the first paper layer remains substantially unchanged.

Preferably, the agent is substantially embedded in a dry state in the second paper layer of the finished paper web or is provided on the second paper layer and only takes effect when it comes into contact with a liquid resin.

Preferably, it is provided that the agent is applied in liquid form, in particular as an aqueous solution, to the fibre web or the resulting paper web or is introduced into this layer. Preferably, this can be done by conventional agents or devices. For example, devices for the production of paper webs are known in which two- or multi-layer paper webs are formed which are provided with a layer of glue for impregnation. Instead of this layer of glue, which would reduce absorbency, the agent for increasing the absorbency can be applied in the present invention.

The invention is further described below with reference to the figure.

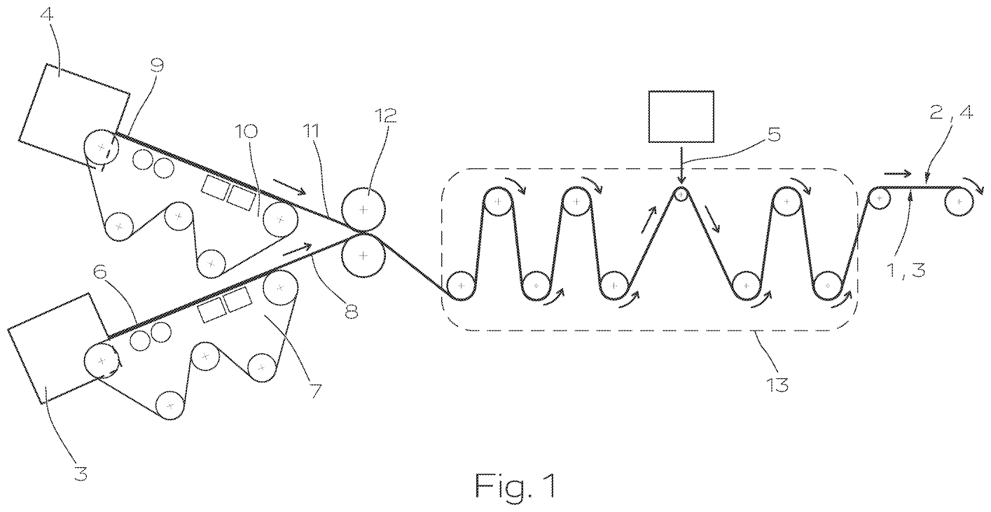

FIG. 1 shows a schematic representation of a device or process for producing a paper web.

In particular, FIG. 1 shows a first paper layer 1, a second paper layer 2, a first material 3, a second material 4, an agent 5 for increasing the absorbency, a first pulp suspension 6, a first wire section 7, a first fibre web 8, a second pulp suspension 9, a second wire section 10, a second fibre web 11, a press section 12, as well as a dryer section 13.

During the production of the paper web, a first paper layer 1 and a second paper layer 2 are planarly bonded together. In particular, the two paper layers 1, 2 extend parallel to each other and lie against each other with their flat sides. Optionally in all embodiments, it may be provided that the two paper layers 1, 2 are at least partially mixed with each other in their contact area.

In the present embodiment, two headboxes are provided for producing the paper web. A first pulp suspension 6 is applied to the first wire section 7 via the first headbox. The first pulp suspension 6 comprises the first material 3. In the first wire section 7, a first fibre web 8 is preferably formed from the first pulp suspension 6.

The second pulp suspension 9 is optionally applied via the second headbox to a second wire section 10. The second pulp suspension 9 contains the second material 4. In the second wire section 10, a second fibre web 11 is optionally formed from the second pulp suspension 9.

In all embodiments, the schematically illustrated structure of the two wire sections 7, 10 can be designed as a top former or as a gap or double wire former.

The two materials 3, 4 have different compositions. For example, the second material 4 contains a higher recovered paper content and/or ash content or exclusively recovered paper fibres. Preferably, the first material 3 contains a higher fresh fibre content or exclusively fresh fibres. The position of paper layers 1 and 2 can be adjusted according to requirements.

In the present embodiment, the two fibre webs 8, 11 are pressed together in the press section 12 in order to bond them together.

Alternatively, the two paper layers 1 and 2 may also be formed in a single wire section. In particular, a first pulp suspension 6 may be applied to this wire section first and the second pulp suspension 9 at a later time or simultaneously.

In the present embodiment, the composite fibre web, which now, after the press section 12, comprises the first fibre web 8 and the second fibre web 11, is passed through the dryer section 13 and dried to form a paper web. The first paper layer 1 is substantially formed from the first fibre web 8. The second paper layer 2 is substantially formed from the second fibre web 11.

As the paper web is formed, an agent 5 is added to increase the resin absorbency in the second paper layer 2. In particular, this agent 5 is applied to the second paper layer 2 or to the second fibre web 11.

Alternatively or preferably, it may also be provided that the second pulp suspension 9 already contains the agent 5 and optionally also agent 5 is additionally added. In particular, the agent can be added to the second pulp suspension 9 before the wire section.

In the present embodiment, the agent 5 is applied in the dryer section 13. For example, the agent 5 is applied as an aqueous solution or undiluted and dried in the dryer section 13 so that the second paper layer 2 contains the substantially dry agent 5 or that the agent 5 is applied to the second paper layer 2 substantially dry.

Alternatively, however, the agent 5 may also be applied or introduced at another stage of the production process, for example in the area of the second wire section 10, in the area of the press section 12 or between the press section 12 and the dryer section 13 or in the area of the dryer section 13.

At the end of the process, the paper web is preferably wound onto a roll and cut to a certain length. This paper web, supplied on the roll, can then be unrolled, impregnated with a resin and then used in a single layer or stacked in multiple layers to form a layer or core for a laminated board.

The paper web comprises a first paper layer 1 made of a first material 3 and a second paper layer 2 which is planarly bonded to the first paper layer 1 and is made of a second material 4. The first material 3 of the first paper layer 1 has a higher degree of resin absorbency than the second material 4 of the second paper layer 2. In order to achieve uniform impregnation with resin during a subsequent impregnation of the paper web with resin, the second paper layer 2 is provided with an agent 5 for increasing the resin absorbency. In particular, the agent 5 of the second paper layer 2 reduces the surface tension of the resin in the area of the second paper layer 2.

Preferably, in all embodiments, the second paper layer 2 is provided with the agent 5 for increasing the resin absorbency. The first paper layer 1 preferably does not comprise an agent 5 and is therefore substantially free of the agent 5. As a result, the absorbency of the first paper layer 1 remains substantially unchanged.

The finished product, i.e. the finished paper web contains surfactants that are preferably substantially dry on or included in the second paper layer 2.

The device or method described forms a paper web which is suitable and/or configured to form a layer and, in particular, the core layer of a laminated board by impregnating a paper web with a resin and subsequent curing of the resin.

In the claims:

1. A paper web which is suitable for and/or configured to form a layer, in particular the core layer of a laminated board, by impregnating the paper web with a resin and subsequent curing of the resin, comprising:
a first paper layer made of a first material,
a second paper layer which is planarly bonded to the first paper layer and is made of a second material,
wherein the first material of the first paper layer has a higher degree of resin absorbency than the second material of the second paper layer, wherein
the second paper layer is provided with an agent for increasing the resin absorbency.

2. The paper web according to claim 1, wherein the agent for increasing the absorbency:
is or contains an agent for improving the capillarity of the second paper layer,
and/or is or contains an agent for improving the penetration of the resin at the paper-resin contact interface,
and/or is or contains an agent for reducing the surface tension of the resin,
and/or is or contains a surfactant, such as in particular a non-ionic and/or a cationic and/or an anionic and preferably a non-foaming surfactant.

3. The paper web according to claim 1, wherein the agent is provided substantially dry in or on the second paper layer of the finished paper web and, on contact with the liquid resin, reduces the surface tension thereof and thereby increases the absorbency of the second paper layer and/or improves the capillarity.

4. The paper web according to claim 1, wherein
the second paper layer in the dry state contains between 20 g/t and 40 g/t, preferably about 30 g/t to 35 g/t, of the agent.

5. The paper web according to claim 1, wherein the second material of the second paper layer without the agent for increasing the absorbency has a 20% to 90% lower resin absorbency than the first material of the first paper layer, the absorbency being the capillary rise after 10 min in machine direction determined according to the international standard ISO 8787:1986.

6. The paper web according to claim 1, wherein
the first paper layer has an absorbency according to ISO 8787:1986 after 10 minutes of 25 to 90 mm in the paper machine direction,
and/or that the second paper layer provided with the agent for increasing the absorbency has an absorbency according to ISO 8787:1986 of 19 to 85 mm in the paper machine direction after 10 minutes,
and/or that the first paper layer has a greater absorbency than the second paper layer by a maximum of 30%.

7. The paper web according to claim 1, wherein
the first material of the first paper layer has a higher fresh fibre content than the second material of the second paper layer,
and/or that the second material of the second paper layer has a higher recovered paper content than the first material of the first paper layer,
and/or that the first material of the first paper layer contains up to 100% fresh fibre and/or up to max. 30% recovered paper,
and/or that the second material of the second paper layer contains up to 100% recovered paper,
and/or that the total ash content in the paper web is 2-12% according to ISO 2144:2019.

8. The paper web according to claim 1, wherein
the paper web has a grammage of 140 to 250 g/m² according to the ISO 536:2019 standard.

9. The paper web according to claim 1, wherein
the paper web has a density of 450 to 580 kg/m³ according to the ISO 534:2011 standard.

10. The paper web according to claim 1, wherein
the paper web has an air permeability according to Gurley of 6 to 20 s according to the ISO 5636-5:2013 standard.

11. The paper web according to claim 1, wherein
the paper web has a wet tensile strength in the machine direction of 0.9 to 1 kN/m according to the ISO 3781:2011 standard.

12. The paper web according to claim 1, wherein
the paper web has a pH value in the cold water extract of 6.6 to 8.5 according to the ISO 6588-1:2020 standard,
and/or the paper web has an average length-weighted fibre length of 1.6 to 2.2 mm according to the ISO 16065-2:2014 standard.

13. The paper web according to claim 1, wherein it is configured as a double layer impregnable kraft paper, i.e. in particular as a so-called double layer saturating kraft paper.

14. A method for producing a paper web which is suitable for and/or configured to form a layer, in particular the core layer of a laminated board, by impregnating the paper web with a resin and subsequent curing of the resin, and which is formed in particular according to claim 1, comprising the following steps:
forming the paper web, having a first paper layer made of a first material and a second paper layer which is planarly bonded to the first paper layer and is made of a second material,
wherein the first material of the first paper layer has a higher degree of resin absorbency than the second material of the second paper layer, wherein
the second material of the second paper layer is provided with an agent for increasing the resin absorbency.

15. The method according to claim 14, wherein the agent for increasing the absorbency:
is or contains an agent for improving the capillarity of the second paper layer,
and/or is or contains an agent for improving the penetration of the resin at the paper-resin contact interface
and/or is or contains an agent for reducing the surface tension of the resin,
and/or is or contains a surfactant, such as in particular a non-ionic and/or a cationic and/or an anionic and preferably a non-foaming surfactant.

16. The method according to claim 14, wherein
a first pulp suspension for forming the first paper layer from the first material is applied to a first wire section in order to form a first fibre web,
in that a second pulp suspension for forming the second paper layer from the second material is applied to a second wire section in order to form a second fibre web,
and that subsequently, in particular in the wire section or in a press section, the first fibre web and the second fibre web are planarly bonded together and dried in a dryer section in order to form the paper web.

17. The method according to claim 14, wherein the second fibre web or the second paper layer is provided with the agent for increasing the absorbency before or after the second wire section and/or in the dryer section.

18. The method according to claim 14, wherein
the agent for increasing the absorbency is applied or introduced in liquid form, in particular as an aqueous solution, to the second fibre web or to the second paper layer,
and the agent is dried together with the two materials of the paper layers in the dryer section,
so the agent is provided substantially dry in or on the second paper layer of the finished paper web and, on contact with the liquid resin, reduces its surface tension and/or improves capillarity and thereby increases the absorbency of the second paper layer.
